(19) United States
(12) Patent Application Publication
(10) Pub. No.: US 2022/0099519 A1
(43) Pub. Date: Mar. 31, 2022

(54) METHOD FOR DETECTING GAS-STORING PERFORMANCE OF SOLUTION-MINED SALT CAVERN IN HIGH-INSOLUBLE SALT MINE

(71) Applicant: Institute of Rock and Soil Mechanics, Chinese Academy of Sciences, Wuhan City (CN)

(72) Inventors: Xilin SHI, Wuhan City (CN); Hongling MA, Wuhan City (CN); Yinping LI, Wuhan City (CN); Chunhe YANG, Wuhan City (CN); Xin LIU, Wuhan City (CN)

(21) Appl. No.: 17/131,608

(22) Filed: Dec. 22, 2020

(30) Foreign Application Priority Data
Sep. 29, 2020 (CN) 202011048920.2

(51) Int. Cl. G01M 3/26; G01B 17/06; E21B 47/10; E21B 47/06; E21B 33/12; E21B 29/00; E21B 49/00; E21B 47/005; B65G 5/00

(52) U.S. Cl. CPC G01M 3/26; G01B 17/06; E21B 47/10; E21B 47/06; B65G 5/00; E21B 29/002; E21B 49/00; E21B 47/005; E21B 33/12

(57) ABSTRACT

The present disclosure discloses a method for detecting gas-storing performance of solution-mined salt cavern in a high-insoluble salt mine, comprising: detecting water-tightness of the cavern and water-tightness of a wellbore; arranging a gas sealing tubing in a production casing for the wellbore, and arranging a packer; detecting gas-tightness of the wellbore; injecting test gas into the cavern through the gas sealing tubing at a gas-injection well; calculating a volume of a discharged brine; closing the debrining well, and injecting the test gas into the cavern through the gas sealing tubing at the gas-injection well; after a pressure value above a gas-liquid interface in the cavern reaches a set pressure value, closing the gas-injection well; and detecting gas-tightness of the cavern. The method can be used for effectively, accurately and economically detecting the available gas storing space volume and the gas-tightness of the solution-mined salt cavern in salt mine.

### CROSS-REFERENCE TO RELATED APPLICATIONS

This application claims the priority of Chinese Patent Application No. 202011048920.2, filed with China Patent Office on Sep. 29, 2020, which is incorporated herein by reference in its entirety.

### TECHNICAL FIELD

The present disclosure relates to the technical field of construction of salt cavern gas storage, and in particular to a method for detecting gas-storing performance of solution-mined salt cavern in a high-insoluble salt mine.

### BACKGROUND OF THE INVENTION

Peak-regulating reserves of natural gas in China are seriously insufficient. With rapid development of novel methods of energy storage such as pure power stations of compressed gas and underground hydrogen storage, a large number of underground gas storage need to be built in an urgent need.

In order to reduce construction cost of salt cavern gas storage and accelerate construction speed of the salt cavern gas storage, currently proposed method is generally to rebuild a solution-mined salt cavern in a salt mine into the salt cavern gas storage. A basic implementation process of reconstruction includes: modifying a wellbore of the solution-mined salt cavern in the salt mine, so that the modified wellbore meets gas-tightness requirement; and injecting gas to be stored into the solution-mined salt cavern in the salt mine through the modified wellbore so as to replace brine in the solution-mined salt cavern in the salt mine to finally form the salt cavern gas storage.

However, content of impurities in most of salt mine in China is high. Gas-tightness of these non-salt impurities is poorer than that of salt layer. In addition, the salt-mining technology for purpose of brine-extraction is relatively rough, which may easily lead to the fact that the solution-mined salt cavern in the salt mine may not meet high standards and high requirements of the salt cavern gas storage. Therefore, before the solution-mined salt cavern in the salt mine is rebuilt into the salt cavern gas storage, a volume of available gas storing space and gas-tightness of the solution-mined salt cavern in the salt mine must be detected, so that gas-storing performance of the solution-mined salt cavern in the salt mine can be accurately evaluated to reduce technical and economic risks.

At present, in detection of the gas-storing performance of the solution-mined salt cavern in the salt mine, there are mainly following two problems:

(1) In a process of water-soluble mining in a high-insoluble salt mine, sediment formed due to dissolution of impurities is largely buried in the solution-mined salt cavern in the salt mine. The only way of guaranteeing scale of construction of the high-insoluble salt mine is to utilize gaps among the sediment to store gas. However, currently and widely adopted technology of sonar survey in a cavern cannot detect boundary of the solution-mined salt cavern in the salt mine buried by the sediment, so that a volume of the available gas storing space of the solution-mined salt cavern in the salt mine is difficult to be evaluated. Therefore, feasibility evaluation of construction of the salt cavern gas storage lacks necessary basic data.

(2) Because that gas-tightness of well cementation and wellhead device at a brine-extracted well in the salt mine does not meet requirements for gas-tightness, and that a production casing for the brine-extracted well in the salt mine has been seriously corroded after many years of service, it is difficult for the brine-extracted well to be directly used for detection of the gas-tightness. According to requirements for the construction of the salt cavern gas storage, modification of casing milling process for full-well section of brine-extracted well, or construction of new well after the brine-extracted well is plugged, will lead to high investment costs. Moreover, if reconstructed solution-mined salt cavern in the salt mine is detected to be unable to meet requirements for the salt cavern gas storage, all investment costs cannot be recovered.

Therefore, how to provide an effective and economical method for detecting gas-storing performance of solution-mined salt cavern in a high-insoluble salt mine has great engineering demand and application value.

### SUMMARY OF THE INVENTION

The present disclosure is intended to overcome disadvantages in the prior art and provide a method for detecting gas-storing performance of solution-mined salt cavern in a high-insoluble salt mine. With the method according to the present disclosure, a volume of available gas storing space and gas-tightness of the solution-mined salt cavern in the high-insoluble salt mine can be effectively, accurately and economically detect.

In an aspect of the present disclosure, one or more embodiments of the present disclosure provide the method for detecting gas-storing performance of solution-mined salt cavern in a high-insoluble salt mine, may comprising: detecting water-tightness of a cavern and water-tightness of a wellbore; under the condition that the water-tightness of the cavern and the water-tightness of the wellbore meet a detection standard for water-tightness, arranging a gas sealing tubing in a production casing for the wellbore, and arranging a packer; detecting gas-tightness of the wellbore; under the condition that the gas-tightness of the wellbore meets a detection standard for gas-tightness, injecting test gas into the cavern through the gas sealing tubing at a gas-injection well, so that brine in the cavern is discharged through the gas sealing tubing at a debrining well; when the test gas starts to be discharged from the debrining well, calculating a volume of the brine discharged; closing the debrining well (when the test gas is discharged from the debrining well, the debrining well is closed), and then injecting the test gas into the cavern through the gas sealing tubing at the gas-injection well; after a pressure value above a gas-liquid interface in the cavern reaches a set pressure value, closing the gas-injection well; and detecting gas-tightness of the cavern.

In one or more embodiments of the present disclosure, before the water-tightness of the cavern and the water-tightness of the wellbore are detected, it is not possible to determine which of a vertical well and/or a deviated well in a salt mine (both of the wells both contain water, without gas) is the gas-injection well or the debrining well; after the water-tightness of the cavern and the water-tightness of the wellbore are detected, which is the gas-injection well or the debrining well is determined according to result of a well logging and a sonar survey on the cavern and the wellbore; wherein a well corresponding to the cavern with higher cavern top is the gas-injection well, and a well corresponding to the cavern with lower cavern top is the debrining well; and wherein a height of the cavern top is a distance between a point of minimum buried depth of the cavern and a point of maximum buried depth of the cavern.

In one or more embodiments of the present disclosure, the detecting the water-tightness of the cavern and the water-tightness of the wellbore, may comprise: closing one of the gas-injection well and the debrining well, and injecting a test liquid into the wellbore and the cavern; monitoring a pressure value at a wellhead of the gas-injection well and/or a pressure value at a wellhead of the debrining well; after the pressure value at the wellhead of the gas-injection well and/or the pressure value at the wellhead of the debrining well reach a set pressure value, closing another one of the gas-injection well and the debrining well; monitoring and obtaining a pressure value at the wellhead of the gas-injection well and/or a pressure value at the wellhead of the debrining well; and according to the pressure value at the wellhead of the gas-injection well and/or the pressure value at the wellhead of the debrining well, evaluating the water-tightness of the cavern and the water-tightness of the wellbore.

In one or more embodiments of the present disclosure, the method for detecting gas-storing performance of solution-mined salt cavern in a high-insoluble salt mine of the present disclosure may further comprise: calculating a volume of an available gas storing space of the cavern according to the volume of the brine discharged and a depth of the gas-liquid interface in the cavern.

In one or more embodiments of the present disclosure, the method for detecting gas-storing performance of solution-mined salt cavern in a high-insoluble salt mine of the present disclosure may further comprise: under the condition that the water-tightness of the cavern and the water-tightness of the wellbore do not meet the detection standard for water-tightness, forging and milling the production casing for the wellbore and a cement ring outside the production casing, so that an open hole is formed in the wellbore; and arranging the gas sealing tubing in the production casing for the wellbore, and arranging a packer in the open hole.

In one or more embodiments of the present disclosure, the cavern may comprise a vertical well section and a deviated well section; the gas-injection well is the vertical well or the deviated well; and the debrining well is the vertical well or the deviated well.

In one or more embodiments of the present disclosure, before the water-tightness of the cavern and the water-tightness of the wellbore are detected, a well pigging, a well logging and a sonar survey are sequentially conducted on the cavern and the wellbore; and according to result of the well pigging and the sonar survey, a height of the cavern top of the vertical well section (the cavern top of the cavern including the vertical well section) is compared with a height of the cavern top of the deviated well section (the cavern top of the cavern including the deviated well section); wherein the well corresponding to the cavern with the higher cavern top is the gas-injection well, and the well corresponding to the cavern with the lower cavern top is the debrining well; wherein the height of the cavern top is the distance between the point of the minimum buried depth of the cavern and the point of the maximum buried depth of the cavern.

In one or more embodiments of the present disclosure, the gas-injection well is the vertical well; and the debrining well is the deviated well.

In one or more embodiments of the present disclosure, the detecting gas-tightness of the wellbore, may comprise: closing the debrining well, and injecting the test gas that is compressed into a high-pressure state into the wellbore and the cavern through the gas sealing tubing in the wellbore; when a pressure value in the wellbore and a pressure value in the cavern reach a set pressure value, closing the gas-injection well; observing whether the wellhead of the gas-injection well or the wellhead of the debrining well overflows the test gas; and if none of the wellhead of the gas-injection well and the wellhead of the debrining well overflows the test gas, the gas-tightness of the wellbore meeting the detection standard for gas-tightness.

In one or more embodiments of the present disclosure, the packer is arranged in the production casing for the wellbore; and the packer is located on an upper portion of the cavern top of the cavern and is close to the cavern top of the cavern.

In one or more embodiments of the present disclosure, a brine tank is connected to the wellhead of the debrining well and the wellhead of the gas-injection well; the brine tank is configured to separate the brine and the test gas that are discharged from the debrining well, and buffer the brine that is discharged from the debrining well and the gas-injection well; and a submersible pump of brine is arranged in the brine tank and is configured to discharge brine in the brine tank.

In one or more embodiments of the present disclosure, the method for detecting gas-storing performance of solution-mined salt cavern in a high-insoluble salt mine of the present disclosure may further comprise: before detecting the water-tightness of the cavern and the water-tightness of the wellbore, sequentially conducting the well pigging, the well logging and the sonar survey on the cavern and the wellbore; wherein, conducting the well pigging, may comprise: removing fouling objects on an inner wall of the production casing for the wellbore; conducting the well logging may comprise: detecting a well cementation quality of the wellbore, a well deviation of the production casing for the wellbore, and lithology of stratum in the production casing for the wellbore, to determine a depth of a cavern top of the cavern; and conducting the sonar survey, may comprise: placing a sonar probe into the cavern through the production casing for the wellbore so as to detect a three-dimensional shape of the cavern.

In one or more embodiments of the present disclosure, the detecting the water-tightness of the cavern and the water-tightness of the wellbore, may comprise: closing the gas-injection well, and injecting the test liquid into the wellbore and the cavern; monitoring the pressure value at the wellhead of the gas-injection well and/or the pressure value at the wellhead of the debrining well; after the pressure value at the wellhead of the gas-injection well and/or the pressure value at the wellhead of the debrining well reach the set pressure value, closing the debrining well; monitoring and obtaining the pressure value at the wellhead of the gas-injection well and/or the pressure value at the wellhead of the debrining well; and according to the pressure value at the wellhead of the gas-injection well and/or the pressure value at the wellhead of the debrining well, evaluating the water-tightness of the cavern and the water-tightness of the wellbore.

In one or more embodiments of the present disclosure, the detecting the water-tightness of the cavern and the water-tightness of the wellbore, may comprise: closing the debrining well, and injecting the test liquid into the wellbore and the cavern; monitoring the pressure value at the wellhead of the gas-injection well and/or the pressure value at the wellhead of the debrining well; after the pressure value at the wellhead of the gas-injection well and/or the pressure value at the wellhead of the debrining well reach the set pressure value, closing the gas-injection well; monitoring and obtaining the pressure value at the wellhead of the gas-injection well and/or the pressure value at the wellhead of the debrining well; and according to the pressure value at the wellhead of the gas-injection well and/or the pressure value at the wellhead of the debrining well, evaluating the water-tightness of the cavern and the water-tightness of the wellbore.

In one or more embodiments of the present disclosure, the detecting the water-tightness of the cavern and the water-tightness of the wellbore, may comprise the following steps (1)-(2).

As for step (1), one of the gas-injection well and the debrining well is closed, and the test liquid is injected into the wellbore and the cavern; a pressure value at the wellhead of the gas-injection well and/or a pressure value at the wellhead of the debrining well are monitored; after the pressure value at the wellhead of the gas-injection well and/or the pressure value at the debrining well reach the set pressure value, another one of the gas-injection well and the debrining well is closed; and a pressure value at the wellhead of the gas-injection well and/or a pressure value at the debrining well are monitored and obtained.

As for step (2), according to the pressure value at the wellhead of the gas-injection well and/or the pressure value at the wellhead of the debrining well, the water-tightness of the cavern and the water-tightness of the wellbore are evaluated; wherein the pressure value at the wellhead of the gas-injection well and/or the pressure value at the debrining well are continuously observed, and a relation curve of the pressure at the wellhead of the gas-injection well and/or the pressure at the wellhead of the debrining well relative to time is drawn; according to the relation curve, rates of descend of the pressure at the wellhead of the gas-injection well and/or the pressure at the wellhead of the debrining well are calculated; if the rates of descend of the pressure at the wellhead of the gas-injection well and/or the pressure at the wellhead of the debrining well are greater than critical pressure drop rate Δ\dot{P}_{B} of brine (based on positive correlation between the critical pressure drop rate Δ\dot{P}_{B} of brine and a mining volume of the cavern, the critical pressure drop rate Δ\dot{P}_{B} of brine is calculated. Wherein, a relation curve of the pressure relative to time is drawn; and after the relation curve is derived, Δ\dot{P}_{B} is calculated), the step (1) is repeated every 1-2 days, and the rates of descend of the pressure at the wellhead of the gas-injection well and/or the pressure at the wellhead of the debrining well are calculated one time; after performing the above calculation more than three times, if the rates of descend of the pressure at the wellhead of the gas-injection well and/or the pressure at the wellhead of the debrining well are greater than the critical pressure drop rate Δ\dot{P}_{B} of brine, it means that the water-tightness of the cavern and the water-tightness of the wellbore do not meet the detection standard for water-tightness; after performing the above calculation more than three times, if the rates of descend of the pressure at the wellhead of the gas-injection well and/or the pressure at the wellhead of the debrining well are not greater than the critical pressure drop rate Δ\dot{P}_{B} of brine, it means that the water-tightness of the cavern and the water-tightness of the wellbore meet the detection standard for water-tightness; and wherein the critical pressure drop rate Δ\dot{P}_{B} of brine is positive correlation with the mining volume of the cavern.

In one or more embodiments of the present disclosure, the detecting the gas-tightness of the cavern and the gas-tightness of the wellbore, may comprise: closing the debrining well, and injecting the test gas into the cavern; monitoring and obtaining a pressure value at the wellhead of the gas-injection well; after the pressure value at the wellhead of the gas-injection well reaches the set pressure value, closing the gas-injection well, and monitoring and obtaining a pressure value at the wellhead of the gas-injection well; and according to the pressure value at the wellhead of the gas-injection well, evaluating the gas-tightness of the cavern.

In one or more embodiments of the present disclosure, the detecting the gas-tightness of the cavern, may comprise the following steps (a)˜(b).

As for step (a), the debrining well is closed, and the test gas is injected into the cavern; a pressure value at the wellhead of the gas-injection well is monitored and obtained; after the pressure value at the wellhead of the gas-injection well reaches a set pressure value, the gas-injection well is closed, and the pressure value at the wellhead of the gas-injection well is monitored and obtained.

As for step (b), the gas-tightness of the cavern is detected according to the pressure value at the wellhead of the gas-injection well; wherein the pressure value at the wellhead of the gas-injection well is continuously observed, and a relation curve of the pressure at the wellhead of the gas-injection well relative to time is drawn; according to the relation curve, a rate of descend of the pressure at the wellhead of the gas-injection well is calculated; if the rate of descend of the pressure at the wellhead of the gas-injection well is greater than critical pressure drop rate Δ\dot{P}_{G} of gas (based on positive correlation between the critical pressure drop rate Δ\dot{P}_{G} of gas and a mining volume of the cavern, Δ\dot{P}_{G} is calculated. Wherein, a relation curve of the pressure relative to time is drawn; and after the relation curve is derived, Δ\dot{P}_{G} is calculated), the step (a) is repeated every 1-2 days, and the rate of descend of the pressure at the wellhead of the gas-injection well is calculated one time; after performing the above calculation more than three times, if the rate of descend of the pressure at the wellhead of the gas-injection well is greater than the critical pressure drop rate Δ\dot{P}_{G} of gas, it means that the gas-tightness of the cavern does not meet the detection standard for gas-tightness; after performing the above calculation more than three times, if the rate of descend of the pressure at the wellhead of the gas-injection well is not greater than the critical pressure drop rate Δ\dot{P}_{G} of gas, it means that the gas-tightness of the cavern meet the detection standard for gas-tightness; and wherein the critical pressure drop rate Δ\dot{P}_{G} of gas is in positive correlation with the mining volume of the cavern.

In one or more embodiments of the present disclosure, a first valve and a second valve are respectively mounted at the wellhead of the gas-injection well or the wellhead of the debrining well; wherein the first valve is configured for closing the production casing for the gas-injection well or the debrining well, and the second valve is configured for closing the gas sealing tubing at the gas-injection well or the debrining well.

In one or more embodiments of the present disclosure, the method for detecting gas-storing performance of solution-mined salt cavern in a high-insoluble salt mine of the present disclosure may further comprise: under the condition that the water-tightness of the cavern and the water-tightness of the wellbore do not meet the detection standard for water-tightness, forging and milling the production casing for the wellbore and the cement ring outside the production casing so as to form the open hole in the wellbore; and then detecting the water-tightness of the cavern and the water-tightness of the wellbore again; under the condition that the water-tightness of the cavern and the water-tightness of the wellbore meet the detection standard for water-tightness, arranging the gas sealing tubing in the production casing for the wellbore, and arranging the packer in the open hole; detecting the gas-tightness of the wellbore; under the condition that the gas-tightness of the wellbore meets the detection standard for gas-tightness, injecting the test gas into the cavern through the gas sealing tubing at the gas-injection well, so that the brine in the cavern is discharged through the gas sealing tubing at the debrining well; when the test gas starts to be discharged from the debrining well, calculating the volume of the brine discharged; closing the debrining well, and injecting the test gas into the cavern through the gas sealing tubing at the gas-injection well; after the pressure value above the gas-liquid interface in the cavern reaches the set pressure value, closing the gas-injection well; and then detecting the gas-tightness of the cavern.

In one or more embodiments of the present disclosure, the wellbore is communicated with the cavern, and the production casing is located in the wellbore.

In one or more embodiments of the present disclosure, the gas sealing tubing is arranged in the production casing, and is configured to convey the test gas from ground to the cavern; the packer is located on the upper portion of the cavern top of the cavern, and is close to the cavern top of the cavern; and the packer is configured to prevent gas from leaking through the production casing or a cement ring.

In one or more embodiments of the present disclosure, under the condition that the gas-tightness of the wellbore meets the detection standard for gas-tightness, the test gas is injected into the cavern through the gas sealing tubing at the gas-injection well, so that the brine in the cavern is discharged through the gas sealing tubing at the debrining well; when the test gas is discharged from the debrining well, the debrining well is closed, and the volume of the brine discharged is calculated; the volume of the available gas storing space of the cavern is calculated according to the volume of the brine discharged and the depth of the gas-liquid interface in the cavern; the test gas is injected into the cavern through the gas sealing tubing at the gas-injection well until the pressure value above the gas-liquid interface in the cavern reaches the set pressure value; the gas-injection well is closed; and the gas-tightness of the cavern is detected; wherein, if the cavern needs to be reconstructed into an underground gas storage of compressed air energy storage power station, air is injected into the wellbore and the cavern through the gas sealing tubing using a gas compressor; and if the cavern needs to be reconstructed into an underground natural gas storage, nitrogen is injected into the wellbore and the cavern through the gas sealing tubing using a gas compressor.

In one or more embodiments of the present disclosure, in a process of the removing fouling objects on the inner wall of the production casing for the wellbore, the fouling objects may include, but is not limited to, salt crystals and/or rust and corrosion products.

In one or more embodiments of the present disclosure, a process of the well pigging is adopted to facilitate arrangement of the gas sealing tubing, the packer, and instruments for the well logging/sonar survey.

In one or more embodiments of the present disclosure, in a process of the well logging, method of detecting in the production casing for the wellbore may include, but is not limited to, acoustic-variable density logging, gamma logging, and downhole television logging.

In one or more embodiments of the present disclosure, in a process of the sonar survey, prior to a process of placing the sonar probe into the cavern, the production casing for the wellbore is subjected to tubing cutting so as to eliminate interference of the production casing to sonar signal; wherein the tubing cutting can be a hydraulic cutting or other downhole tools.

In one or more embodiments of the present disclosure, the method for detecting gas-storing performance of solution-mined salt cavern in a high-insoluble salt mine according to the present disclosure may further comprise: the fact that the water-tightness of the cavern and the water-tightness of the wellbore do not meet the detection standard for water-tightness indicating the water-tightness of the production casing for the wellbore and the water-tightness of the cement ring outside the production casing have failed; forging and milling the production casing for the wellbore and the cement ring outside the production casing, so that the open hole is formed in the wellbore; arranging the packer in the production casing for the wellbore, and arranging the packer at well section with the open hole. In the aforementioned technical solution, hydraulic tools of forging and milling can be used for forging and milling the production casing for the wellbore and the cement ring outside the production casing so as to form the well section with the open hole in the wellbore.

In one or more embodiments of the present disclosure, the method for detecting gas-storing performance of solution-mined salt cavern in a high-insoluble salt mine according to the present disclosure may further comprise: under the condition that the water-tightness of the cavern and the water-tightness of the wellbore do not meet the detection standard for water-tightness, forging and milling the production casing for the wellbore and the cement ring outside the production casing, so that the well section with the open hole is formed in the wellbore; arranging the gas sealing tubing in the production casing for the wellbore, and arranging the packer in the well section with the open hole so as to prevent gas from leaking through the production casing for the wellbore or the cement ring outside the production casing.

In one or more embodiments of the present disclosure, the method for detecting gas-storing performance of solution-mined salt cavern in a high-insoluble salt mine according to the present disclosure may further comprise:

When the gas-tightness of the wellbore does not meet the detection standard for gas-tightness, and when it can be determined that failure to meet the detection standard for gas-tightness is not caused by the gas sealing tubing or the packer, it can be determined that the gas-tightness of the wellbore has failed; at this time, the detection of the gas-storing performance of the cavern can be stopped.

In one or more embodiments of the present disclosure, the depth of the gas-liquid interface can be obtained by pressure balance algorithm or detection means.

In one or more embodiments of the present disclosure, after the gas-tightness of the cavern is detected, fresh water or brine is injected into the debrining well so as to discharge gas in the cavern from the gas-injection well until the gas in the cavern is completely discharged; wherein, in a process of injecting fresh water or brine into the debrining well, maintaining mutual coordination between a gas-discharge speed and a water-injection speed can prevent collapse of the cavern caused by low pressure inside the cavern, and can prevent deformation of the production casing for wellbore or collapse of the cavern which caused by negative pressure inside the gas-injection well.

In one or more embodiments of the present disclosure, the test gas can be air and/or nitrogen.

In one or more embodiments of the present disclosure, the test liquid can be saturated brine.

In one or more embodiments of the present disclosure, the saturated brine may contain NaCl with a concentration of ≥300 g/L.

In one or more embodiments of the present disclosure, the method for detecting gas-storing performance of solution-mined salt cavern in a high-insoluble salt mine according to the present disclosure may further comprise: after the gas-tightness of the cavern is detected, injecting the fresh water or the brine into the debrining well, so that the gas is discharged from the gas-injection well until the gas in the cavern is completely discharged.

In one or more embodiments of the present disclosure, the method for detecting gas-storing performance of solution-mined salt cavern in a high-insoluble salt mine of the present disclosure may further comprise: calculating a volume of an available gas storing space of the cavern according to the volume of the brine discharged and a depth of the gas-liquid interface in the cavern; wherein, obtaining the depth of the gas-liquid interface in the cavern may comprise:

When the test gas starts to be discharged from the debrining well, readings of pressure at the wellhead of the gas-injection well or the wellhead of the debrining well (the readings of the pressure can be obtained through a first pressure gauge or a second pressure gauge; when the reading of the pressure changes by 0.1 MPa (or 0.02 MPa, 0.04 MPa, 0.06 MPa, 0.08 MPa, and the like) at a time, the gas sealing tubing at the gas-injection well can be suspended to inject the test gas into the cavern so as to obtain more accurate readings of the pressure) are continuously monitored; the depth of the gas-liquid interface in the cavern can be calculated according to principle of fluid pressure balance; and wherein, method of calculating the depth of the gas-liquid interface in the cavern may comprise: assuming that the depth of the gas-liquid interface in the cavern is an unknown quantity, and taking position of the gas-liquid interface in the cavern as a reference point of pressure balance; then calculating the depth of the gas-liquid interface in the cavern by solving linear equation with one unknown according to principle of fluid pressure balance of the communicating vessel.

In one or more embodiments of the present disclosure, a brine tank is connected to the wellhead of the debrining well and the wellhead of the gas-injection well; the brine tank is configured to separate the brine and the test gas that are discharged from the debrining well, and buffer the brine that is discharged from the debrining well and the gas-injection well; wherein the brine tank can be configured to separate the brine and the gas which are discharged from the debrining well (belonging to safety protection measures), so as to prevent high-pressure gas from overflowing and damaging to apparatus of brine plant; when it is observed that the test gas overflows from the brine tank, it indicates that the gas-liquid interface in the cavern has dropped to a lowest point; and at the time, according to calculated total volume of the brine discharged, a minimum volume of available gas storing space of the solution-mined salt cavern can be obtained.

One or more embodiments provided in the present disclosure have at least the following technical effects or advantages:

(1) With the method for detecting gas-storing performance of solution-mined salt cavern in a high-insoluble salt mine according to the present disclosure, an old well of the solution-mined salt cavern in the salt mine can be used for detection, without need for large-scale reconstruction engineering or rebuilding of the wellbore; and the volume of available gas storing space of the solution-mined salt cavern can be efficiently and accurately detected.

(2) Content of insoluble impurities in salt-containing strata in salt mine in China is very high. In this type of the salt mine, the solution-mined salt cavern in the salt mine formed after a solution mining with butted well is covered by sediment formed by dissolving a large amount of impurities. Existing technology of sonar detection cannot accurately detect the volume of the available gas storing space of the cavern. In addition, in most salt mines in China, production casings for wells that have been in service for many years have different degrees of corrosion problems, which make it difficult for the gas-tightness of the wellbore and the cavern to meet the detection standard for gas-tightness. With the method for detecting gas-storing performance of solution-mined salt cavern in a high-insoluble salt mine according to the present disclosure, before the water-tightness of the cavern and the water-tightness of the wellbore are detected, the cavern and the wellbore are sequentially subjected to the well pigging, the well logging and the sonar survey, so that some technical effects can be realized. As for the technical effects, an effective volume of available gas storing space in gaps among the sediment formed by dissolving a large amount of impurities can be calculated, so that defect that the effective volume of available gas storing space in the cavern is evaluated only by using a technology of sonar detection at present is overcome; detection obstacles caused by the sediment can be overcome, and the volume of the available gas storing space in the cavern can be detected efficiently and accurately; the gas-tightness of the cavern can be directly detected, and gas storage performance of the cavern can be efficiently and accurately evaluated.

(3) In the method for detecting gas-storing performance of solution-mined salt cavern in a high-insoluble salt mine according to the present disclosure, a medium used for detecting performance of a salt cavern gas storage can be gas, and a storage medium in the salt cavern gas storage is also gas; therefore, detection result of detection method according to the present disclosure is highly reliable, and engineering risk is effectively reduced.

### BRIEF DESCRIPTION OF THE DRAWINGS

In order to more clearly illustrate the technical solutions of the embodiments of the present disclosure, the drawings that need to be used in the embodiment description are described hereinafter. Obviously, the drawings in the following description are some embodiments of the present disclosure. For those skilled in the art, other drawings can be obtained according to these drawings without involving any inventive effort.

FIG. 1 shows a flow chart of a method for detecting gas-storing performance of solution-mined salt cavern in a high-insoluble salt mine according to one or more embodiments of the present disclosure;

FIG. 2 shows a schematic diagram of the method for detecting gas-storing performance of solution-mined salt cavern in a high-insoluble salt mine according to one or more embodiments of the present disclosure; and

FIG. 3 shows a state diagram of the method for detecting gas-storing performance of solution-mined salt cavern in a high-insoluble salt mine according to one or more embodiments of the present disclosure when a packer is arranged at a well section with an open hole.

### DETAILED DESCRIPTION OF THE INVENTION

The present disclosure will now be described more clearly in conjunction with the specific embodiments and examples, and the advantages and various effects of the present disclosure will become more apparent from the detailed description and the examples. It should be understood by those skilled in the art that these specific embodiments and examples are intended to be illustrative of the present disclosure rather than limiting.

Throughout the specification, terms used herein should be understood to have the meanings as commonly used in the art, unless specifically stated otherwise. Therefore, unless otherwise defined, all technical and scientific terms used herein have the same meaning as commonly understood by one of ordinary skill in the art to which this disclosure belongs. If the conflict exists, the specification is prioritized.

Unless specifically stated otherwise, the various raw materials, reagents, instruments, apparatus and the like used in the present disclosure can be obtained through market purchase or can be prepared through the existing method.

According to the technical solution provided by one or more embodiments of the present disclosure, technical problems are solved, and general ideas are as follows:

In some embodiments of the present disclosure, a method for detecting gas-storing performance of solution-mined salt cavern in a high-insoluble salt mine is provided, and the method may comprise: detecting water-tightness of a cavern and water-tightness of a wellbore; under the condition that the water-tightness of the cavern and the water-tightness of the wellbore meet a detection standard for water-tightness, arranging a gas sealing tubing in a production casing for the wellbore, and arranging a packer; detecting gas-tightness of the wellbore; under the condition that the gas-tightness of the wellbore meets a detection standard for gas-tightness, injecting test gas into the cavern through the gas sealing tubing at a gas-injection well, so that brine in the cavern is discharged through the gas sealing tubing at a debrining well; when the test gas starts to be discharged from the debrining well, calculating a volume of the brine discharged; closing the debrining well (when the test gas starts to be discharged from the debrining well, the debrining well is closed), and then injecting the test gas into the cavern through the gas sealing tubing at the gas-injection well; after a pressure value above a gas-liquid interface in the cavern reaches a set pressure value, closing the gas-injection well; and detecting gas-tightness of the cavern.

With the method for detecting gas-storing performance of solution-mined salt cavern in a high-insoluble salt mine according to the present disclosure, an effective volume of available gas storing space in gaps among sediment formed by dissolving a large amount of impurities can be detected, so that defect that the effective volume of available gas storing space of solution-mined salt cavern in a salt-mine is evaluated only by using a technology of sonar detection at present can be overcome. In addition, with the method provided by the present disclosure, an old well of the solution-mined salt cavern in the salt mine can be used for detection, without need for large-scale reconstruction engineering or re-drilling of the wellbore.

With the method for detecting gas-storing performance of solution-mined salt cavern in a high-insoluble salt mine according to the present disclosure, a detection result of the method is highly reliable, engineering risk is effectively reduced, and defect that the effective volume of the available gas storing space in the cavern is evaluated only by using a technology of sonar detection at present can be overcome.

In some embodiments of the present disclosure, the method for detecting gas-storing performance of solution-mined salt cavern in a high-insoluble salt mine of the present disclosure may further comprise: calculating a volume of an available gas storing space of the cavern according to the volume of the brine discharged and a depth of the gas-liquid interface in the cavern.

Content of insoluble impurities in salt-containing strata in salt mine in China is very high. In this type of the salt mine, the solution-mined salt cavern in the salt mine, which is formed after solution mining with butted well, is covered by the sediment formed by dissolving a large amount of impurities. Existing technology of sonar detection cannot accurately detect the volume of the available gas storing space of the cavern. In addition, in most salt mines in China, production casings for wells that have been in service for many years have different degrees of corrosion problems, which makes it difficult for the gas-tightness of the wellbore and the cavern to meet the detection standard for gas-tightness. With the method for detecting gas-storing performance of solution-mined salt cavern in a high-insoluble salt mine according to the present disclosure, before the water-tightness of the cavern and the water-tightness of the wellbore are detected, the cavern and the wellbore are sequentially subjected to a well pigging, a well logging and a sonar survey, so that some technical effects can be realized. As for the technical effects, an effective volume of available gas storing space in gaps among the sediment formed by dissolving a large amount of impurities can be calculated, so that defect that the effective volume of available gas storing space in the cavern is evaluated only by using a technology of sonar detection at present can be overcome; detection obstacles caused by the sediment can be overcome, and the volume of the available gas storing space in the cavern can be detected efficiently and accurately; gas-tightness detection of the cavern can be directly detected, and gas storage performance of the cavern can be efficiently and accurately evaluated.

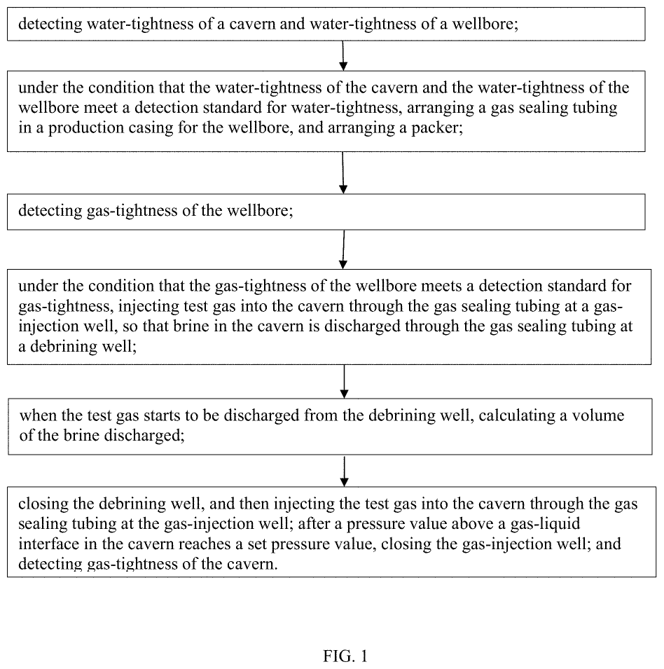

The method for detecting gas-storing performance of solution-mined salt cavern in a high-insoluble salt mine according to one or more embodiments of the present disclosure is described in detail below in conjunction with FIGS. 1-3 provided by the present disclosure.

The method for detecting gas-storing performance of solution-mined salt cavern in a high-insoluble salt mine provided by the present disclosure, may comprise: detecting the water-tightness of the cavern and the water-tightness of the wellbore; under the condition that the water-tightness of the cavern and the water-tightness of the wellbore meet the detection standard for water-tightness, arranging the gas sealing tubing in the production casing for the wellbore, and arranging the packer; detecting the gas-tightness of the wellbore; under the condition that the gas-tightness of the wellbore meets the detection standard for gas-tightness, injecting the test gas into the cavern through the gas sealing tubing at the gas-injection well, so that the brine in the cavern is discharged through the gas sealing tubing at the debrining well; when the test gas starts to be discharged from the debrining well, calculating the volume of the brine discharged; closing the debrining well, and then injecting the test gas into the cavern through the gas sealing tubing at the gas-injection well; after the pressure value above the gas-liquid interface in the cavern reaches the set pressure value, closing the gas-injection well, and then detecting the gas-tightness of the cavern.

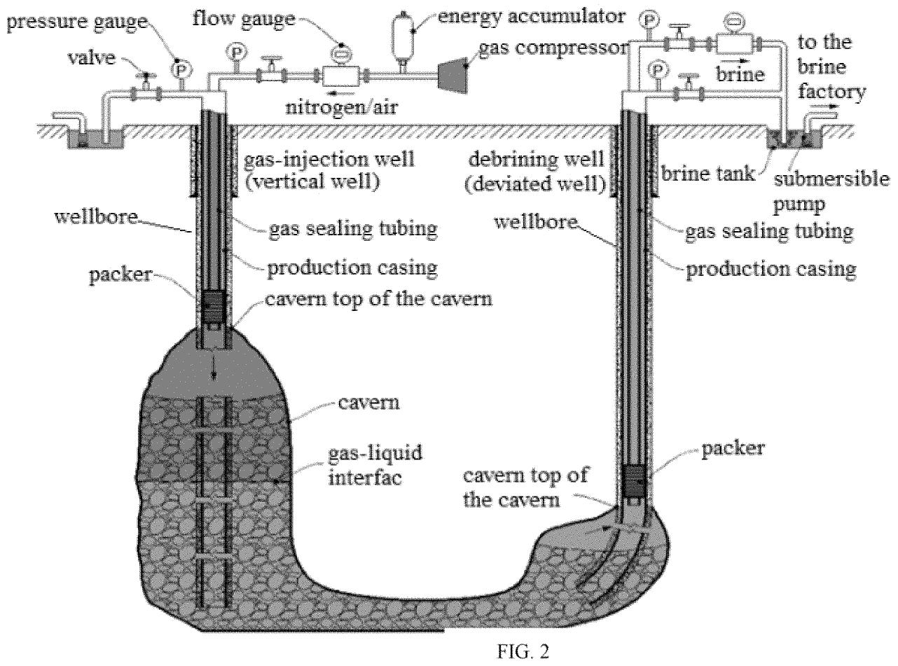

FIG. 1 shows a flow chart of the method for detecting gas-storing performance of solution-mined salt cavern in a high-insoluble salt mine according to one or more embodiments of the present disclosure. FIG. 2 shows a schematic diagram of the method for detecting gas-storing performance of solution-mined salt cavern in a high-insoluble salt mine according to one or more embodiments of the present disclosure. As shown in FIG. 1 and FIG. 2, in some embodiments of the present disclosure, the method for detecting gas-storing performance of gas storage in salt mine may comprise the following steps S1˜S7.

As for step S1, before the water-tightness of the cavern and the water-tightness of the wellbore are detected, the well pigging, the well logging and the sonar survey are sequentially conducted on the cavern and the wellbore.

As for step S2, the detecting the water-tightness of the cavern and the water-tightness of the wellbore, may comprise: closing one of the gas-injection well and the debrining well, and injecting a test liquid into the wellbore and the cavern; monitoring a pressure value at a wellhead of the gas-injection well and/or a pressure value at a wellhead of the debrining well; after the pressure value at the wellhead of the gas-injection well and/or the pressure value at the wellhead of the debrining well reach a set pressure value, closing another one of the gas-injection well and the debrining well; monitoring and obtaining a pressure value at the wellhead of the gas-injection well and/or a pressure value at the wellhead of the debrining well; and according to the pressure value at the wellhead of the gas-injection well and/or the pressure value at the wellhead the debrining well, evaluating the water-tightness of the cavern and the water-tightness of the wellbore. Wherein, pressure values at the wellheads of the gas-injection well and debrining well (the gas-injection well and debrining well are closed) are continuously monitored, and a relation curve of the pressure value relative to time is draw. According to the relation curve, changes of the pressures relative to times are evaluated. When the pressure values at the wellheads of the gas-injection well and debrining well (the gas-injection well and debrining well are closed) remain constant, it indicates that the water-tightness of the cavern and the water-tightness of the wellbore meets the standard.

As for step S3, under the condition that the water-tightness of the cavern and the water-tightness of the wellbore meet the detection standard for water-tightness, the gas sealing tubing is arranged in the production casing for the wellbore, and the packer is arranged.

As for step S4, the detecting the gas-tightness of the wellbore, may comprise: closing the debrining well, and injecting the test gas that is compressed into a high-pressure state into the wellbore and the cavern through the gas sealing tubing in the wellbore; when a pressure value in the wellbore and a pressure value in the cavern reach a set pressure value, closing the gas-injection well; observing whether the wellhead of the gas-injection well or the wellhead of the debrining well overflows the test gas; and if none of the wellhead of the gas-injection well and the wellhead of the debrining well overflows the test gas, the gas-tightness of the wellbore meeting the detection standard for gas-tightness.

As for step S5, under the condition that the gas-tightness of the wellbore meets the detection standard for gas-tightness, the test gas is injected into the cavern through the gas sealing tubing at the gas-injection well, so that the brine in the cavern is discharged through the gas sealing tubing at the debrining well; when the test gas starts to be discharged in the debrining well, the volume of the discharged brine is calculated.

As for step S6, the debrining well is closed, and then the test gas is injected into the cavern through the gas sealing tubing at the gas-injection well; after the pressure value above the gas-liquid interface in the cavern reaches the set pressure value, the gas-injection well is closed, and then the gas-tightness of the cavern is detected.

As for step S7, after the gas-tightness of the cavern is detected, fresh water or brine is injected into the debrining well so as to discharge gas in the cavern from the gas-injection well until the gas in the cavern is completely discharged.

In some embodiments of the present disclosure, before the water-tightness of the cavern and the water-tightness of the wellbore are detected, it is not possible to determine which of a vertical well and/or a deviated well in a salt mine (both of the wells contain water, without gas) is the gas-injection well or a debrining well; after the water-tightness of the cavern and the water-tightness of the wellbore are detected, which is the gas-injection well or the debrining well is determined according to a result of the well logging and the sonar survey on the cavern and the wellbore; wherein a well corresponding to the cavern with higher cavern top is the gas-injection well, and a well corresponding to the cavern with lower cavern top is the debrining well; and wherein a height of the cavern top is a distance between a point of a minimum buried depth of the cavern and a point of maximum buried depth of the cavern.

In some embodiments of the present disclosure, the method for detecting gas-storing performance of solution-mined salt cavern in a high-insoluble salt mine of the present disclosure may further comprise: calculating a volume of an available gas storing space of the cavern according to the volume of the brine discharged and a depth of the gas-liquid interface in the cavern.

In some embodiments of the present disclosure, the method for detecting gas-storing performance of solution-mined salt cavern in a high-insoluble salt mine provided by the present disclosure may further comprise: under the condition that the water-tightness of the cavern and the water-tightness of the wellbore do not meet the detection standard for water-tightness, forging and milling the production casing for the wellbore and a cement ring outside the production casing, so that an open hole is formed in the wellbore; and arranging the gas sealing tubing in the production casing for the wellbore, and arranging a packer in the open hole. The above technical solution can prevent gas from leaking through the production casing for the wellbore or a cement ring outside the production casing.

In some embodiments of the present disclosure, the cavern may comprise a vertical well section and a deviated well section; the gas-injection well can be the vertical well or the deviated well; and the debrining well can be the vertical well or the deviated well.

In some embodiments of the present disclosure, before the water-tightness of the cavern and the water-tightness of the wellbore are detected, the well pigging, the well logging and the sonar survey are sequentially conducted on the cavern and the wellbore; according to the result of the well pigging and the sonar survey, a height of the cavern top of the vertical well section (the cavern top of the cavern includes the vertical well section) is compared with a height of the cavern top of the deviated well section (the cavern top of the cavern includes the deviated well section); wherein the well corresponding to a cavern with the higher cavern top is the gas-injection well, and the well corresponding to the cavern with the lower cavern top is the debrining well; and wherein the height of the cavern top is the distance between the point of the minimum buried depth of the cavern and the point of the maximum buried depth of the cavern.

In some embodiments of the present disclosure, the gas-injection well is the vertical well; and the debrining well is the deviated well.

In some embodiments of the present disclosure, the packer is arranged in the production casing for the wellbore; the packer is located on an upper portion of the cavern top of the cavern and is close to the cavern top of the cavern.

In some embodiments of the present disclosure, a brine tank is connected to the wellhead of the debrining well and the wellhead of the gas-injection well; the brine tank is configured to separate the brine and the test gas that are discharged from the debrining well, and buffer the brine that is discharged from the debrining well and the gas-injection well; and a submersible pump of brine is arranged in the brine tank and is configured to discharge brine in the brine tank.

In some embodiments of the present disclosure, the method for detecting gas-storing performance of solution-mined salt cavern in a high-insoluble salt mine provided by the present disclosure may further comprise: before detecting the water-tightness of the cavern and the water-tightness of the wellbore, sequentially conducting the well pigging, the well logging and the sonar survey on the cavern and the wellbore; wherein, conducting the well pigging, may comprise: removing fouling objects on an inner wall of the production casing for the wellbore; conducting the well logging may comprise: detecting a well cementation quality of the wellbore, a well deviation of the production casing for the wellbore, and lithology of stratum in the production casing for the wellbore, to determine a depth of a cavern top of the cavern; and conducting the sonar survey may comprise: placing a sonar probe into the cavern through the production casing for the wellbore so as to detect a three-dimensional shape of the cavern.

In some embodiments of the present disclosure, detecting the water-tightness of the cavern and the water-tightness of the wellbore, may comprise: closing the gas-injection well, and injecting the test liquid into the wellbore and the cavern; monitoring the pressure value at the wellhead of the gas-injection well and/or the pressure value at the wellhead of the debrining well; after the pressure value at the wellhead of the gas-injection well and/or the pressure value at the wellhead of the debrining well reach the set pressure value, closing the debrining well; monitoring and obtaining the pressure value at the wellhead of the gas-injection well and/or the pressure value at the wellhead of the debrining well; and according to the pressure value at the wellhead of the gas-injection well and/or the pressure value at the wellhead of the debrining well, evaluating the water-tightness of the cavern and the water-tightness of the wellbore.

In some embodiments of the present disclosure, detecting the water-tightness of the wellbore and the water-tightness of the cavern in the salt cavern gas storage, may comprise: closing the debrining well, and injecting the test liquid into the wellbore and the cavern; monitoring the pressure value at the wellhead of the gas-injection well and/or the pressure value at the wellhead of the debrining well; after the pressure value at the wellhead of the gas-injection well and/or the pressure at the wellhead of the debrining well reach the set pressure value, closing the gas-injection well; monitoring and obtaining the pressure value at the wellhead of the gas-injection well and/or the pressure value at the wellhead of the debrining well; and according to the pressure value at the wellhead of the gas-injection well and/or the pressure value at the wellhead of the debrining well, evaluating the water-tightness of the cavern and the water-tightness of the wellbore.

In some embodiments of the present disclosure, the detecting the water-tightness of the cavern and the water-tightness of the wellbore, may comprise the following steps (1)˜(2).

As for step (1), one of the gas-injection well and the debrining well is closed, and the test liquid is injected into the wellbore and the cavern; a pressure value at the wellhead of the gas-injection well and/or a pressure value at the wellhead of the debrining well are monitored; after the pressure value at the wellhead of the gas-injection well and/or the pressure value at the debrining well reach the set pressure value, another one of the gas-injection well and the debrining well is closed; and a pressure value at the wellhead of the gas-injection well and/or a pressure value at the debrining well are monitored and obtained.

As for step (2), according to the pressure value at the wellhead of the gas-injection well and/or the pressure value at the wellhead of the debrining well, the water-tightness of the cavern and the water-tightness of the wellbore are evaluated; wherein the pressure value at the wellhead of the gas-injection well and/or the pressure value at the debrining well are continuously observed, and a relation curve of the pressure at the wellhead of the gas-injection well and/or the pressure at the wellhead of the debrining well relative to time is drawn; according to the relation curve, rates of descend of the pressure at the wellhead of the gas-injection well and/or the pressure at the debrining well are calculated; if the rates of descend of the pressure at the wellhead of the gas-injection well and/or the pressure at the wellhead of the debrining well are greater than critical pressure drop rate Δ\dot{P}_{B} of brine (based on positive correlation between the critical pressure drop rate Δ\dot{P}_{B} of brine and a mining volume of the cavern, the critical pressure drop rate Δ\dot{P}_{B} of brine is calculated), the step (1) is repeated every 1-2 days, and the rates of descend of the pressure at the wellhead of the gas-injection well and/or the pressure at the wellhead of the debrining well are calculated one time; after performing the above calculation more than three times, if the rates of descend of the pressure at the wellhead of the gas-injection well and/or the pressure at the wellhead of the debrining well are greater than the critical pressure drop rate Δ\dot{P}_{B} of brine, it means that the water-tightness of the cavern and the water-tightness of the wellbore do not meet the detection standard for water-tightness; after performing the above calculation more than three times, if the rates of descend of the pressure at the wellhead of the gas-injection well and/or the pressure at the wellhead of the debrining well are not greater than the critical pressure drop rate Δ\dot{P}_{B} of brine, it means that the water-tightness of the cavern and the wellbore meets the detection standard for water-tightness; and wherein the critical pressure drop rate Δ\dot{P}_{B} of brine is positive correlation with the mining volume of the cavern.

In some embodiments of the present disclosure, the detecting the gas-tightness of the cavern, may comprise the following steps (a)˜(b).

As for step (a), the debrining well is closed, and the test gas is injected into the cavern; a pressure value at the wellhead of the gas-injection well is monitored and obtained; after the pressure value at the wellhead of the gas-injection well reaches the set pressure value, the gas-injection well is closed, and a pressure value at the wellhead of the gas-injection is monitored and obtained.

As for step (b), the gas-tightness of the cavern is detected according to the pressure value at the wellhead of the gas-injection well; wherein the pressure value at the wellhead of the gas-injection well is continuously observed, and a relation curve of the pressure at the wellhead of the gas-injection well relative to time is drawn; according to the relation curve, a rate of descend of the pressure at the wellhead of the gas-injection well is calculated; if the rate of descend of the pressure at the wellhead of the gas-injection well is greater than critical pressure drop rate Δ\dot{P}_{G} of gas (based on positive correlation between the critical pressure drop rate Δ\dot{P}_{G} of gas and a mining volume of the cavern, Δ\dot{P}_{G} is calculated), the step (a) is repeated every 1-2 days, and the rate of descend of the pressure at the wellhead of the gas-injection well is calculated one time; after performing the above calculation more than three times, if the rate of descend of the pressure at the wellhead of the gas-injection well is greater than the critical pressure drop rate Δ\dot{P}_{G} of gas, it means that the gas-tightness of the cavern does not meet the detection standard for gas-tightness; after performing the above calculation more than three times, if the rate of descend of the pressure at the wellhead of the gas-injection well is not greater than the critical pressure drop rate Δ\dot{P}_{G} of gas, it means that the gas-tightness of the cavern meet the detection standard for gas-tightness; and wherein the critical pressure drop rate Δ\dot{P}_{G} of gas is in positive correlation with the mining volume of the cavern.

In some embodiments of the present disclosure, a first valve and a second valve are respectively mounted at the wellhead of the gas-injection well or the wellhead of the debrining well; wherein the first valve is configured for closing the production casing for the gas-injection well or the debrining well, and the second valve is configured for closing the gas sealing tubing at the gas-injection well or the debrining well.

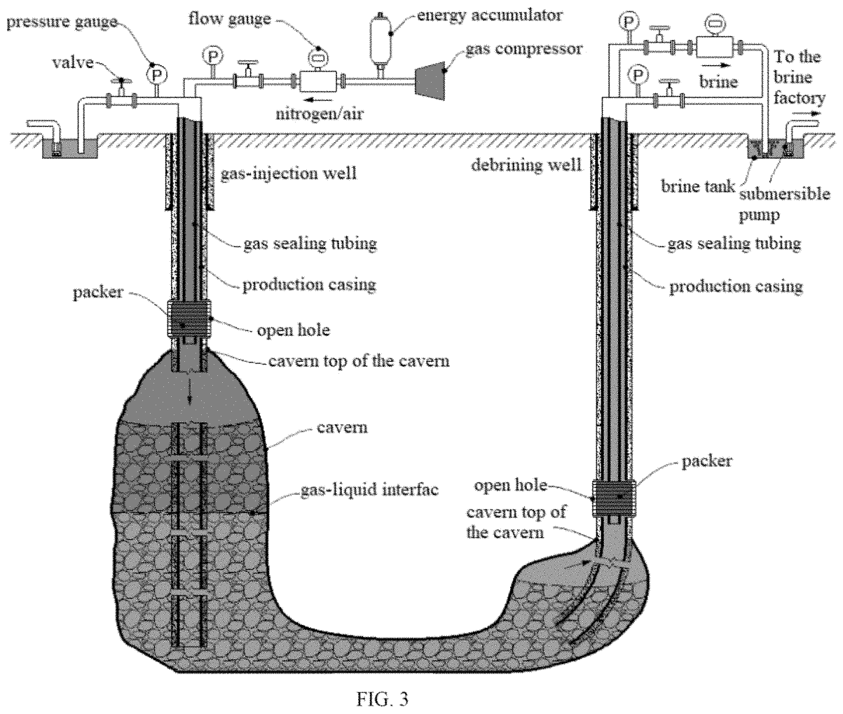

In some embodiments of the present disclosure, the method for detecting gas-storing performance of solution-mined salt cavern in a high-insoluble salt mine, may further comprise: under the condition that the water-tightness of the cavern and the water-tightness of the wellbore do not meet the detection standard for water-tightness, forging and milling the production casing for the wellbore and the cement ring outside the production casing so as to form the open hole in the wellbore; and then detecting the water-tightness of the cavern and the water-tightness of the wellbore again; under the condition that the water-tightness of the cavern and the water-tightness of the wellbore meet the detection standard for water-tightness, arranging the gas sealing tubing in the production casing of the wellbore, and arranging the packer in the open hole, as shown in FIG. 3; detecting the gas-tightness of the wellbore; under the condition that the gas-tightness of the wellbore meets the detection standard for gas-tightness, injecting the test gas into the cavern through the gas sealing tubing at the gas-injection well, so that the brine in the cavern is discharged through the gas sealing tubing at the debrining well; when the test gas starts to be discharged from the debrining well, calculating the volume of the brine discharged; closing the debrining well, and then injecting the test gas into the cavern through the gas sealing tubing at the gas-injection well; after the pressure value above the gas-liquid interface in the cavern reaches the set pressure value, closing the gas-injection well; and then detecting the gas-tightness of the cavern.

In some embodiments of the present disclosure, the wellbore is in communication with the cavern, and the production casing is located in the wellbore.

In some embodiments of the present disclosure, the gas sealing tubing is arranged in the production casing, and is configured for conveying the test gas from ground to the cavern; the packer is located on the upper portion of the cavern top of the cavern, and is close to the cavern top of the cavern; and the packer is configured for preventing gas from leaking through the production casing or the cement ring.

In some embodiments of the present disclosure, under the condition that the gas-tightness of the wellbore meets the detection standard for gas-tightness, the test gas is injected into the cavern through the gas sealing tubing at the gas-injection well, so that the brine in the cavern is discharged through the gas sealing tubing at the debrining well; when the test gas starts to be discharged from the debrining well, the debrining well is closed, and the volume of the brine discharged is calculated; the volume of the available gas storing space of the cavern is calculated according to the volume of the brine discharged and the depth of the gas-liquid interface in the cavern; the test gas is injected into the cavern through the gas sealing tubing at the gas-injection well until the pressure value above the gas-liquid interface in the cavern reaches the set pressure value; the gas-injection well is closed, and the gas-tightness of the cavern is detected; wherein, if the cavern is to be reconstructed into an underground gas storage of compressed air energy storage power station, air is injected into the wellbore and the cavern through the gas sealing tubing using a gas compressor; and if the cavern is to be reconstructed into an underground natural gas storage, nitrogen is injected into the wellbore and the cavern through the gas sealing tubing using a gas compressor.

In some embodiments of the present disclosure, in a process of the removing fouling objects on the inner wall of the production casing of the wellbore, the fouling objects may include, but is not limited to, salt crystals and/or rust and corrosion products.

In some embodiments of the present disclosure, the process of the well pigging is adopted to facilitate arrangements of the gas sealing tubing, the packer, and instrument for the well logging/sonar survey.

In some embodiments of the present disclosure, in the process of the well logging, a method of detecting in the production casing for the wellbore may include, but is not limited to, acoustic-variable density logging, gamma logging, and downhole television logging.

In some embodiments of the present disclosure, in the process of the sonar survey, prior to a process of placing the sonar probe into the interior of the cavern, the production casing for the wellbore is subjected to tubing cutting so as to eliminate interference of the production casing to sonar signal; wherein the tubing cutting can adopt a hydraulic cutting knife or other downhole tool.

In some embodiments of the present disclosure, the method for detecting gas-storing performance of solution-mined salt cavern in a high-insoluble salt mine may further comprise: the fact that the water-tightness of the cavern and the water-tightness of the wellbore do not meet the detection standard for water-tightness indicating that the water-tightness of the production casing for the wellbore and the water-tightness of cement ring outside the production casing have failed; forging and milling the production casing of the wellbore and the cement ring outside the production casing, so that an open hole is formed in the wellbore; arranging the packer in the production casing for the wellbore, and arranging the packer at the well section with the open hole. In the aforementioned technical solution, a hydraulic tool of forging and milling can be used for forging and milling the production casing for the wellbore and the cement ring outside the production casing so as to form the well section with the open hole in the wellbore.

In some embodiments of the present disclosure, the method for detecting gas-storing performance of solution-mined salt cavern in a high-insoluble salt mine may further comprise: under the condition that the water-tightness of the cavern and the water-tightness of the wellbore do not meet the detection standard for water-tightness, forging and milling the production casing for the wellbore and the cement ring outside the production casing, so that the well section with the open hole is formed in the wellbore; arranging the gas sealing tubing into the production casing for the wellbore, and arranging the packer in the well section with the open hole so as to prevent gas from leaking through the production casing for the wellbore or the cement ring outside the production casing.

In some embodiments of the present disclosure, the method for detecting gas-storing performance of solution-mined salt cavern in a high-insoluble salt mine may further comprise:

When the gas-tightness of the wellbore does not meet the gas-tightness detection standard, and when it can be determined that failure to meet the detection standard for gas-tightness is not caused by the gas sealing tubing or the packer, it can be determined that the gas-tightness of the wellbore has failed; at this time, the detection of the gas-storing performance of the cavern can be stopped.

In some embodiments of the present disclosure, the depth of the gas-liquid interface can be obtained by pressure balance algorithm or detection means.

In some embodiments of the present disclosure, after the gas-tightness of the cavern is detected, fresh water or brine is injected into the debrining well, so that gas is discharged from the gas-injection well until the gas in the cavern is completely discharged; wherein in a process of injecting fresh water or brine into the debrining well, maintaining a mutual coordination between a gas-discharge speed and a water-injection speed can prevent collapse of the cavern, and can prevent deformation of the production casing for wellbore or collapse of the cavern; wherein the collapse of the cavern is caused by low pressure inside the cavern, and the deformation of the production casing for wellbore or the collapse of the cavern is caused by negative pressure inside the gas-injection well.

In some embodiments of the present disclosure, the test gas can be air and/or nitrogen.

In some embodiments of the present disclosure, the test liquid can be saturated brine.

In some embodiments of the present disclosure, the saturated brine may contain NaCl with a concentration of ≥300 g/L.

In some embodiments of the present disclosure, the method for detecting gas-storing performance of solution-mined salt cavern in a high-insoluble salt mine may further comprise: after detecting the gas-tightness of the cavern, injecting fresh water or brine into the debrining well, so that gas is discharged from the gas-injection well until the gas in the cavern is completely discharged.

In some embodiments of the present disclosure, the method for detecting gas-storing performance of solution-mined salt cavern in a high-insoluble salt mine of the present disclosure may further comprise: calculating a volume of an available gas storing space of the cavern according to the volume of the brine discharged and a depth of the gas-liquid interface in the cavern; wherein, obtaining the depth of the gas-liquid interface in the cavern may comprise:

When the test gas starts to be discharge from the debrining well, the readings of the pressure at the wellhead of the gas-injection well or the wellhead of the debrining well (the readings of the pressure can be obtained through a first pressure gauge or a second pressure gauge; when the reading of pressure changes by 0.1 MPa (or 0.02 MPa, 0.04 MPa, 0.06 MPa, 0.08 MPa, and the like) at a time, the gas sealing tubing at the gas-injection well can be suspended to inject the test gas into the cavern so as to read more accurate readings of the pressure) are continuously monitored; the depth of the gas-liquid interface in the cavern can be calculated according to principle of fluid pressure balance; and wherein, a method of calculating the depth of the gas-liquid interface in the cavern may comprise: assuming that the depth of the gas-liquid interface in the cavern is an unknown amount, and taking a position of the gas-liquid interface in the cavern as a reference point of pressure balance; calculating the depth of the gas-liquid interface in the cavern by solving linear equation with one unknown according to principle of fluid pressure balance of the communicating vessel. The depth of the gas-liquid interface in the cavern may be calculated by following equation:

$${H}_{i n t} = \frac{{P}_{inj} - {P}_{d e b}}{( {ρ}_{b r i} - {ρ}_{gas} ) g}$$

wherein, Hᵢₙₜ represents the depth of gas-liquid interface in the cavern; Pᵢₙⱼ and P_{deb} respectively represent pressure at the wellhead of gas-injection well and debrining well; ρ_{bri} and ρ_{gas} respectively represent density of brine in the debrining well and density of gas in the gas-injection well; g represents the acceleration of gravity.

In some embodiments of the present disclosure, a brine tank is connected to the wellhead of the debrining well and the wellhead of the gas-injection well; the brine tank is configured to separate the brine and the test gas that are discharged from the debrining well and buffer the brine that is discharged from the debrining well and the gas-injection well; wherein the brine tank can be configured to separate the brine and the gas which are discharged from the debrining well (belonging to safety protection measures), so as to prevent high-pressure gas from overflowing and damaging to apparatus of brine plant; when it is observed that the test gas overflows from the brine tank, it indicates that the gas-liquid interface in the cavern has dropped to a lowest point; and at the time, according to a calculated total volume of the brine discharged, a minimum volume of available gas storing space of the solution-mined salt cavern can be obtained.

Finally, it should also be noted that the terms “comprises,” “comprising,” or any other variation thereof, are intended to cover a non-exclusive inclusion, such that a process, method, article, or apparatus that comprises a series of elements not only includes those elements, but also includes other elements not expressly listed, or elements inherent in such process, method, article, or apparatus.

While preferred embodiments of the present disclosure have been described, those skilled in the art, upon attaining a basic inventive concept, may make additional alterations and modifications to these embodiments. Therefore, it is intended that the appended claims are interpreted as including preferred embodiments, and all changes and modifications that fall within the scope of the present disclosure.

It will be apparent to those skilled in the art that various modifications and variations can be made to the present disclosure without departing from the spirit and scope of the present disclosure. Thus, if such modifications and variations of the present disclosure fall within the scope of the claims and equivalent technologies thereof, the present disclosure also intends to include such modifications and variations.

1. A method for detecting gas-storing performance of solution-mined salt cavern in a high-insoluble salt mine, comprising:
detecting water-tightness of a cavern and water-tightness of a wellbore;
under the condition that the water-tightness of the cavern and the water-tightness of the wellbore meet a detection standard for water-tightness, arranging a gas sealing tubing in a production casing for the wellbore, and arranging a packer;
detecting gas-tightness of the wellbore;
under the condition that the gas-tightness of the wellbore meets a detection standard for gas-tightness, injecting test gas into the cavern through the gas sealing tubing at a gas-injection well, so that brine in the cavern is discharged through the gas sealing tubing at a debrining well;
when the test gas starts to be discharged from the debrining well, calculating a volume of the brine discharged;
closing the debrining well, and then injecting the test gas into the cavern through the gas sealing tubing at the gas-injection well;
after a pressure value above a gas-liquid interface in the cavern reaches a set pressure value, closing the gas-injection well; and
detecting gas-tightness of the cavern.

2. The method for detecting gas-storing performance of solution-mined salt cavern in a high-insoluble salt mine according to claim 1, wherein the detecting the water-tightness of the cavern and the water-tightness of the wellbore, comprises:
closing one of the gas-injection well and the debrining well, and injecting a test liquid into the wellbore and the cavern; and
monitoring a pressure value at a wellhead of the gas-injection well and/or a pressure value at a wellhead of the debrining well; after the pressure value at the wellhead of the gas-injection well and/or the pressure value at the wellhead of the debrining well reach a set pressure value, closing another one of the gas-injection well and the debrining well; monitoring and obtaining a pressure value at the wellhead of the gas-injection well and/or a pressure value at the wellhead of the debrining well; and according to the pressure value at the wellhead of the gas-injection well and/or the pressure value at the wellhead of the debrining well, evaluating the water-tightness of the cavern and the water-tightness of the wellbore.

3. The method for detecting gas-storing performance of solution-mined salt cavern in a high-insoluble salt mine according to claim 1, further comprising:
calculating a volume of an available gas storing space of the cavern according to the volume of the brine discharged and a depth of the gas-liquid interface in the cavern.

4. The method for detecting gas-storing performance of solution-mined salt cavern in a high-insoluble salt mine according to claim 1, further comprising:
under the condition that the water-tightness of the cavern and the water-tightness of the wellbore do not meet the detection standard for water-tightness, forging and milling the production casing for the wellbore and a cement ring outside the production casing, so that an open hole is formed in the wellbore; and
arranging the gas sealing tubing in the production casing for the wellbore, and arranging a packer in the open hole.

5. The method for detecting gas-storing performance of solution-mined salt cavern in a high-insoluble salt mine according to claim 1, wherein the cavern comprises a vertical well section and a deviated well section;
the gas-injection well is a vertical well or a deviated well; and
the debrining well is the vertical well or the deviated well.

6. The method for detecting gas-storing performance of solution-mined salt cavern in a high-insoluble salt mine according to claim 5, wherein the gas-injection well is the vertical well, and the debrining well is the deviated well.

7. The method for detecting gas-storing performance of solution-mined salt cavern in a high-insoluble salt mine according to claim 1, wherein the detecting the gas-tightness of the wellbore, comprises:
closing the debrining well, and injecting the test gas that is compressed into a high-pressure state into the wellbore and the cavern through the gas sealing tubing in the wellbore;
when a pressure value in the wellbore and a pressure value in the cavern reach a set pressure value, closing the gas-injection well;
observing whether the wellhead of the gas-injection well or the wellhead of the debrining well overflows the test gas; and
if none of the wellhead of the gas-injection well and the wellhead of the debrining well overflows the test gas, the gas-tightness of the wellbore meeting the detection standard for gas-tightness.

8. The method for detecting gas-storing performance of solution-mined salt cavern in a high-insoluble salt mine according to claim 1, wherein a brine tank is connected to the wellhead of the debrining well and the wellhead of the gas-injection well;
the brine tank is configured to separate the brine and the test gas that are discharged from the debrining well, and buffer the brine that is discharged from the debrining well and the gas-injection well; and
a submersible pump of brine is arranged in the brine tank and is configured to discharge brine in the brine tank.

9. The method for detecting gas-storing performance of solution-mined salt cavern in a high-insoluble salt mine according to claim 1, further comprising:
before detecting the water-tightness of the cavern and the water-tightness of the wellbore, sequentially conducting a well pigging, a well logging and a sonar survey on the cavern and the wellbore;
wherein,
conducting the well pigging, comprises: removing fouling objects on an inner wall of the production casing for the wellbore;
conducting the well logging, comprises: detecting a well cementation quality of the wellbore, a well deviation of the production casing for the wellbore, and lithology of stratum in the production casing for the wellbore, to determine a depth of a cavern top of the cavern; and
conducting the sonar survey, comprises: placing a sonar probe into the cavern through the production casing for the wellbore so as to detect a three-dimensional shape of the cavern.

10. The method for detecting gas-storing performance of solution-mined salt cavern in a high-insoluble salt mine according to claim 1, further comprises:
after detecting the gas-tightness of the cavern, injecting fresh water or brine into the debrining well so as to discharge gas in the cavern from the gas-injection well until the gas in the cavern is completely discharged.

11. The method for detecting gas-storing performance of solution-mined salt cavern in a high-insoluble salt mine according to claim 1, wherein the gas sealing tubing is arranged in the production casing and is configured to convey the test gas from ground to the cavern;
the packer is located on an upper portion of the cavern top of the cavern and is close to the cavern top of the cavern; and
the packer is configured to prevent gas from leaking through the production casing or a cement ring.
